(19) United States
(12) Patent Application Publication
(10) Pub. No.: US 2026/0158559 A1
(43) Pub. Date: Jun. 11, 2026

(54) ADDITIVE MANUFACTURING USING POWDER BED FUSION AND HIGH EFFICIENCY CHARGE NEUTRALISATION

(71) Applicant: WAYLAND ADDITIVE LIMITED, Huddersfield, West Yorkhire (GB)

(72) Inventors: Ian LAIDLER, Huddersfield (GB); Martyn HUSSEY, Manchester (GB); Matthew HARVEY, Manchester (GB); Ismat M Ahmed RUDWAN, Abu Dhabi (AE)

(21) Appl. No.: 19/125,430

(22) PCT Filed: Jun. 12, 2023
(86) PCT No.: PCT/GB2023/051527

§ 371 Date: Apr. 29, 2025

(30) Foreign Application Priority Data
Oct. 31, 2022 (GB) 2216104.6

(51) Int. Cl. B22F 12/44; B22F 10/28; B22F 10/80; B22F 12/41; B33Y 30/00; B33Y 50/00

(52) U.S. Cl. CPC B22F 12/44; B22F 10/28; B22F 10/80; B22F 12/41; B33Y 30/00; B33Y 50/00

(57) ABSTRACT

A powder bed fusion apparatus is provided for use in additive manufacturing, the apparatus comprising: a power supply having an anode and a cathode; an electron source operable to provide an electron beam, wherein the electron source is biased by the power supply; a plasma source operable to provide a plasma containing electrons and positively charged ions; a powder bed arranged to receive the electron beam and the plasma; and a controller configured to control operation of the electron source and the plasma source to form a part as a series of layers, each layer formed by scanning the electron beam over the powder bed to fuse a layer of powder of the powder bed into a desired shape; wherein the plasma source is connected to the anode of the power supply, enabling a circuit in which the ion current, formed by the positively charged ions in the plasma, is balanced by electron current, sourced from the plasma and returning to the power supply via the plasma, such that mitigation, by the ion current, of charging of the powder bed by the electron beam self-regulates.

### FIELD OF INVENTION

The present invention relates to use of a powder bed fusion apparatus in additive manufacturing, and particularly to charge control when irradiating metal powders during electron beam additive layer manufacture.

### TECHNICAL BACKGROUND

One of the most prominent technologies employed for additive manufacturing is powder bed fusion, in which a thin layer of powder—typically metal or plastic—is selectively melted by an energy source such as a laser or electron beam. The melted area of the powder layer forms a cross-sectional part of an article to be built. After the layer has been selectively melted, a new layer of powder is deposited and then also selectively melted so that a complete article is constructed layer-by-layer.

The metal powder is typically a metallic alloy which suffers from a disadvantage in that it tends to oxidise and become insulating or semi-insulating. When in this insulating or semi-insulating state, irradiation with a charged particle beam in a powder bed fusion process, such as a high-energy electron beam, causes the metal powder particles themselves to become charged and to retain that charge or a fraction thereof. As the charge accumulation increases, the metal powder particles experience an increasing Coulombic repulsion, which may result in the metal powder overcoming gravitational and frictional forces acting from the lower powder layer or melted material. The charged powder layer may then become mobile and may even be expelled from the powder bed, destroying the layer-wise additive process instantly and potentially damaging the apparatus. For example, powder may contaminate, and fuse to, components of the apparatus. High voltage electrical arcs may also be formed, and the mobile powder may scatter the electron beam.

### SUMMARY OF INVENTION

According to an aspect of the present invention, there is provided a powder bed fusion apparatus for use in additive manufacturing, the apparatus comprising: a power supply having an anode and a cathode; an electron source operable to provide an electron beam, wherein the electron source is biased by the power supply; a plasma source operable to provide a plasma containing electrons and positively charged ions; a powder bed arranged to receive the electron beam and the plasma; and a controller configured to control operation of the electron source and the plasma source to form a part as a series of layers, each layer formed by scanning the electron beam over the powder bed to fuse a layer of powder of the powder bed into a desired shape; wherein the plasma source is connected to the anode of the power supply, enabling a circuit in which the ion current, formed by the positively charged ions in the plasma, is balanced by electron current, sourced from the plasma and returning to the power supply via the plasma, such that mitigation, by the ion current, of charging of the powder bed by the electron beam self-regulates.

Based on the above, embodiments of the present invention provide an apparatus and method for additive manufacture which employs a charge neutralisation technique to prevent excess charge build-up on the powder bed, caused by the beam used to melt the powder.

During the build process, particles of an opposite charge to the particles used to irradiate the powder bed during additive manufacture act to neutralise the charge on the metal powder particles due to the melting charged particle beam. Excessive charging of the powder bed is thus avoided. The instances of charge-induced movement of the metal powder particles can therefore be significantly reduced, avoiding associated adverse effects.

Techniques disclosed in this application enable optimisation of this mechanism by providing an electrical configuration in which the ion current provided by a plasma source is the same as the electron current produced by an electron source.

This approach enables an efficient charge neutralisation process, since the ion current required to neutralise the negative charge on the powder is substantially equal in magnitude to the current of the electron beam, with the plasma between the plasma source and the powder bed acting as the conduit for charge transfer.

### BRIEF DESCRIPTION OF DRAWINGS

Embodiments of the present invention will be described by way of example only, with reference to the accompanying drawings, in which:

FIG. 1 shows an additive layer manufacture apparatus according to embodiments of the present invention;

FIG. 2 shows an electrical configuration for use with an additive layer manufacture apparatus according to embodiments of the present invention;

FIG. 3 illustrates the effect of a change in neutraliser coupling potential of a plasma discharge chamber used in embodiments of the present invention; and

FIG. 4 shows a method of operating an additive manufacture apparatus according to embodiments of the present invention.

It will be appreciated that for convenience of explanation, some elements of the drawings are not shown to scale.

### DETAILED DESCRIPTION

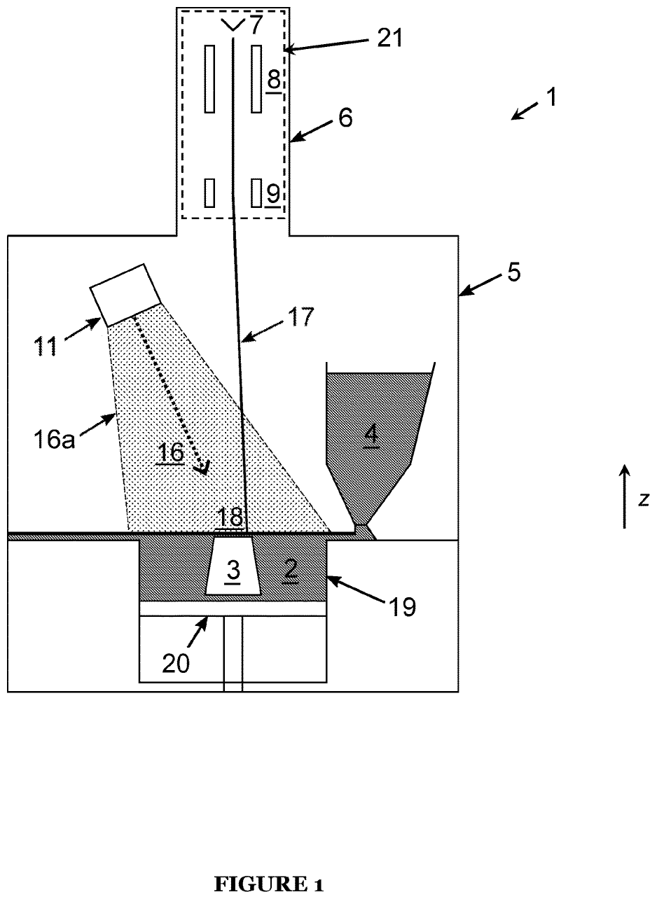

FIG. 1 shows a powder bed fusion apparatus 1 according to embodiments of the present invention. The apparatus 1 shown in FIG. 1 is configured for additive manufacture using an electron beam 17 to melt metal powder to form a part 3 layer-by-layer.

The powder bed fusion apparatus 1 comprises an electron-optical assembly 21 to form, condition and steer an electron beam 17. The electron-optical assembly 21 comprises a cathode 7 of an electron gun, referred to herein as an ‘electron source’, arranged to emit electrons. The electron-optical assembly 21 further comprises an electron extraction and focusing element 8 for forming an electron beam 17 focused at the powder bed from the emitted electrons, which travels along what is shown in FIG. 1 as the z-axis of the apparatus 1. The electron-optical assembly 21 further comprises an electron deflection system 9 for scanning the electron beam 17 over a bed 2 of metal powder, to melt powder into a desired additive manufactured part 3. The electron deflection system 9 comprises electromagnetic deflectors arranged around the electron beam 17.

Operation of the electron optical assembly 21 is controlled via signals derived from a build controller (not shown), such as one or more suitably programmed computers or processors, in accordance with a scan file for the desired part 3, as is known in the art.

The apparatus 1 further comprises at least one hopper 4 operable to dispense powder via a dispensing mechanism (not shown) and a stage 20 to support a build tank 19 positioned to receive the dispensed powder in a volume defining the powder bed 2. The stage 20 is movable in the z-direction via a piston, and the hopper 4 and piston are controlled in conjunction with signals derived from the build controller (not shown).

The apparatus 1 further comprises a plasma source 11 for generating and emitting a plasma or a mixture of ions, electrons and neutral atoms (denoted by 16a in FIG. 1) to be used in a charge neutralisation mechanism used in an additive manufacturing method according to embodiments of the present invention, to be described in more detail below. Operation of the plasma source 11 is controlled via signals derived from the build controller (not shown).

Additive manufacture is performed under vacuum conditions in embodiments of the present invention. Hence the apparatus 1 further comprises a build vacuum chamber 5 in which the focused electron beam 17 and ions 16 travel to the powder bed 2. The ions 16 travel via the region of plasma and neutral atoms 16a which exists between the plasma source 11 and the powder bed 2. Coupled to the build vacuum chamber 5 is a first auxiliary vacuum chamber 6 containing the electron-optical assembly 21. The plasma source 11 is shown as being contained within the build vacuum chamber 5, but may alternatively be contained in a second auxiliary vacuum chamber coupled to the build vacuum chamber 5. Vacuum conditions are maintained, as known in the art in powder fusion systems, with vacuum pressures of the order of 1×10⁻³ mbar to 1×10⁻⁷ mbar.

The hopper 4 dispenses powder so as to deposit a measured quantity of the powder on the powder bed 2 surface. A mechanism such as a scraper or blade (not shown) is used to disperse the powder evenly over the moveable stage 20. The electron-optical assembly 21 forms and steers the electron beam 17 such that the electron beam 17 is scanned over the powder bed 2 to heat and melt the powder and form a solid layer of a part 3. After each layer of the part 3 has been formed, the stage 20 is lowered in the z-direction to accommodate the increasing height of the part 3 and to allow the next layer to be spread.

### Charge Neutralisation

As noted above, the interaction of the negatively charged electron beam 17 with the powder particles can cause the unmelted powder particles to become negatively charged, due to the insulating or semi-insulating oxide layer on the metal powder particles.

In the absence of the charge neutralisation mechanism used in embodiments of the present invention, this can lead to the accumulation of negative charge on the powder which can adversely affect the build process, including build-ending events in which powder particles are displaced from the powder bed 2 due to the Coulombic repulsive force imparted by other charged powder particles of the same charge polarity in the powder bed 2, and travel throughout the build chamber 5.

According to embodiments of the present invention, simultaneous irradiation of the powder bed 2 with both the electron beam 17 and with ions 16 from the plasma source 11, via region 16a, prevents the powder from accumulating excess negative charge, thus avoiding a number of potentially build-ending events caused by excess charge on the powder bed 2, as described above.

During the build process, electrons from the incident electron beam 17 may be elastically backscattered from the surface of the powder bed 2, initiating a process referred to herein as cascade ionisation, which may have a negative impact on the build. The electrons from the incident electron beam 17 may also generate secondary electrons by ionising material at the build surface, and these secondary electrons may be ejected from the surface of the powder bed 2. The backscattered electrons and the secondary electrons can both cause further ionisation of ions and atoms present in the build area (neutral atoms and/or ions emanating from the plasma source 11, or neutral atoms having evaporated from the melt pool 18), producing further electrons which can in turn cause yet further ionisation events.

An electric field is present near the build surface due to the proximity of the positively-biased discharge chamber of the plasma source 11 and the powder bed 2, and due to the positively charged ions 16 surrounding the negatively charged conduit of the electron beam 17. This combined electric field is of a magnitude sufficient to impart additional energy to the secondary electrons in the build area, leading to increased electron-atom interactions and thus playing a significant role in the occurrence of cascade ionisation.

As a result of the processes described above, in the absence of the charge neutralisation mechanism used in embodiments of the present invention, large electron and ion currents are generated within the build volume. The large electron currents generated in the build area may interfere with the operation of the plasma source 11 and the power supplies attached to the plasma source 11. If interference with the operation of the plasma source causes a change to the electric field generated by the ions 16 surrounding the electron beam 17, this can result in the position of the electron beam shifting.

Optimisation of the charge neutralisation mechanism is achieved via implementation of a circuit which ensures that the ion current provided by a plasma source is substantially the same as the electron current produced by an electron source. The electrical circuit automatically provides the correct amount of positive ions required for neutralisation of the negative charge of the electron beam, and is capable of self-adjustment in response to changing conditions in the build area.

### Electrical Configuration

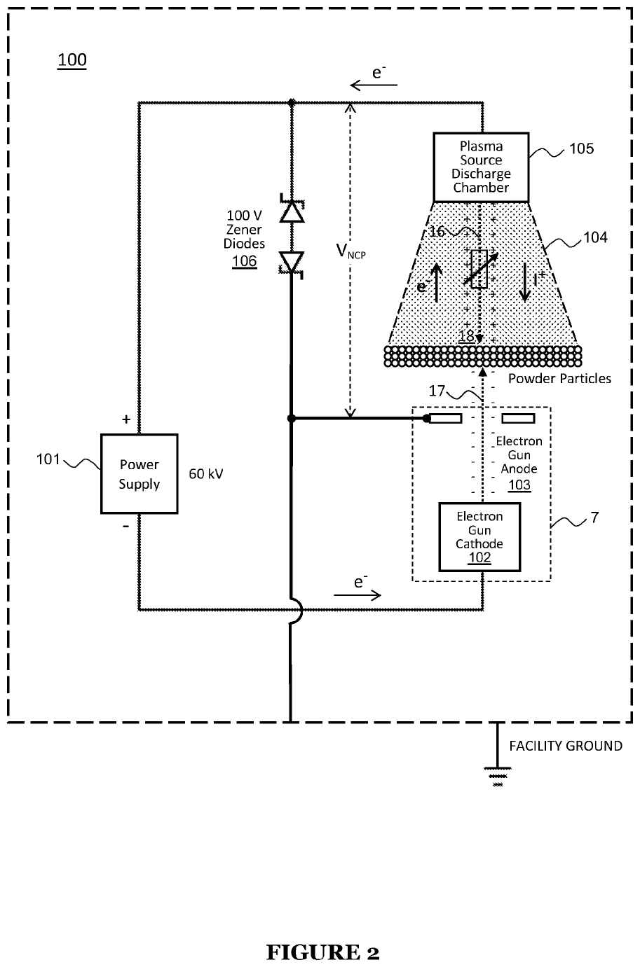

FIG. 2 shows an electrical configuration 100 for use with powder bed fusion apparatus 1 according to embodiments of the present invention. This system enables efficient neutralisation of the electron charge deposited on the powder particles by the melting electron beam 17 (produced by the electron source 7) using positively charged ions 16 (produced by the plasma source 11).

A single high voltage power supply 101 drives the system, which is connected to both the electron source 7 and the plasma source discharge chamber 105 in the manner shown in FIG. 2, and sets an operating voltage range across the system as a whole. The power supply 101 may provide, for example, a potential difference of 60 kV between its terminals.

As shown in FIG. 2, the electron gun cathode 102 is held at a negative potential with respect to the electron gun anode 103, to accelerate the electrons away from the electron source 7 and towards the powder bed creating an electron beam 17. For ease of explanation, the electron source 7 is illustrated below the build surface to represent its negative potential, in contrast to the more positive potential on the plasma discharge chamber, relative to the powder bed fusion apparatus Earth voltage (referred to herein as facility ground). However, in physical terms, the electron source 7 is located on the same side of the build surface as the plasma source discharge chamber 105, in the manner shown in FIG. 1. The electron gun anode 103 is referenced to facility ground. The power bed is represented in FIG. 2 as series of layers of powder particles which are insulated from the build tank 19 and stage 20, such that when the powder bed is irradiated with the electron beam 17, regions of the powder bed become negatively charged. After melting by the electron beam 17, the resulting electrically conductive additive manufactured part 3 is referenced to facility ground via the supporting platform on which the part 3 is built.

The plasma source discharge chamber 105 is connected to the anode of the power supply 101 and is arranged to provide a high-density plasma, comprising ions and electrons, in the space bridging the plasma source 11 and the powder bed surface. This region of plasma, present in the build chamber, is referred to herein as a “plasma bridge” 104, as shown in FIG. 2. The plasma bridge 104 corresponds to region 16a of FIG. 1. The plasma bridge 104 acts as a conduit for charge conduction, thus effectively completing the circuit between the plasma discharge chamber 105 and the electron gun cathode 102 via the powder bed: ions in the plasma are transmitted via plasma bridge 104 to the point or points on the powder bed where negative charge is accumulating due to the incident electron beam 17.

The effective resistance of the conduit is a function of the density of the plasma bridge 104. In this regard, the plasma bridge 104 is represented in FIG. 2 as including a variable resistor. For a given current through the conduit, there can be understood to exist a potential difference across the conduit represented by the product of the current and the effective resistance. This potential difference across the plasma bridge conduit 104 is offset from the potential difference between the plasma source discharge chamber 105 and facility ground, which is referred to herein as the neutraliser coupling potential (V_{NCP}).

In operation, the neutraliser coupling potential of the plasma source discharge chamber 105 automatically adjusts, relative to facility ground, to provide sufficient ion current to neutralise the electron charge accumulating on the powder bed during the build (as will be described in more detail below). The greater the ion current required, the larger (more positive) the neutraliser coupling potential.

The fact that the plasma discharge chamber 105 and the electron gun cathode 102 are connected to the terminals of the same power supply 101, and do not have independent current return paths as a result of the circuit described above, ensures that the same current flows through both. As a result, the correct ion current is provided by the plasma source via the plasma bridge 104 to counteract the current from the electron source. The system can therefore be regarded as “self-adjusting”. In more detail, due to the connection of both the electron gun cathode 102 and the plasma discharge chamber 105 to power supply 101, electrons are provided by the plasma bridge 104 via the plasma source discharge chamber 105 to the electron gun cathode 102, and thus into the electron beam 17. Ions travel in the opposite direction around the circuit (specifically, for every one electron provided by the plasma bridge 104, one ion is provided to the powder bed, where the electron flow in one direction and ion flow in the opposite direction may be considered as the same current flow within the circuit). This results in a highly efficient charge neutralisation process, as ion current is attracted only towards areas of the powder bed of negative charge and requiring neutralisation, and only in the amount required.

In the event the plasma source 11 is not operational or is operating poorly (e.g. where there is zero, or a low density plasma bridge 104 representing a high effective resistance conduit), the neutraliser coupling potential cannot exceed a voltage of, for example, approximately 100 V with respect to facility ground due to, and depending on the type of, back-to-back Zener diodes used. In such a situation, where the electron source 7 is switched on, the neutraliser coupling potential will be +100 V and electrons will be sourced into the electron beam 17 from ground rather than from the plasma bridge 104.

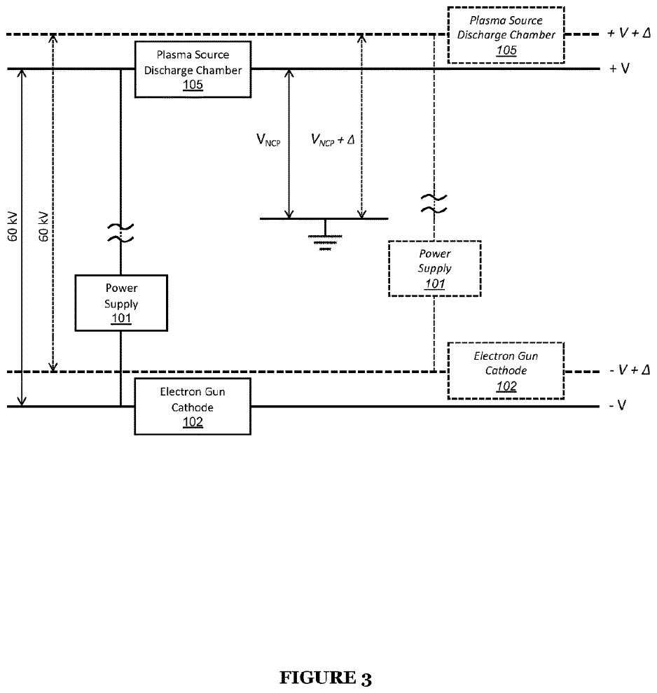

This “self-adjustment” is illustrated in FIG. 3, which shows a change (Δ) in the neutraliser coupling potential (V_{NCP}) of the plasma source discharge chamber 105. It should be noted that the elements of FIG. 3 are not shown to scale, and that V_{NCP} represents a significantly smaller value than the values indicated by the two voltage rails (−V, +V).

A first configuration shows two voltage rails (−V, +V) across which a 60 kV potential difference is provided by power supply 101. Back-to-back Zener diodes 106 ensure that the maximum value for the top rail is +100 V relative to ground. The neutraliser coupling potential of the plasma source discharge chamber 105 relative to ground has a value V_{NCP}.

In response to changes in the electron beam current incident on the powder bed, a larger or smaller neutralising current may be required, and the system re-adjusts accordingly. A second configuration shows an example in which the two voltage rails having adjusted values (−V+Δ, +V+Δ). The 60 kV potential difference between the rails is maintained. This “shift” results in an increase in the neutraliser coupling potential of the plasma source discharge chamber 105 relative to facility ground, V_{NCP}+Δ, leading to an increase in the ion current provided to the powder bed 2.

Where a smaller neutralising current is required, the neutraliser coupling potential of the plasma source discharge chamber 105 relative to facility ground may decrease to V_{NCP}−Δ.

It is clear, from FIG. 3 that the voltage between the electron source 7 and the plasma source discharge chamber 105 is unchanged. In the likely scenario, during a build process, that A is small, with respect to the 60kV voltage employed by the electron source, it will follow that there is only a small change in the voltage of the electron gun cathode 102 with respect to facility ground.

The ion current provided by the plasma source, which matches the electron current produced by the electron source, may have a value of approximately 50 mA. In the absence of the electrical configuration 100 described above, higher ion currents occur between the plasma source discharge chamber 105 and ground during operation, leading to a significantly higher current demand (for example, as high as 1 A) than is required for neutralising the electron beam.

### Plasma Source

In the embodiments illustrated in FIG. 1, a plasma source 11 is shown, which is embodied as a plasma flood source. The plasma source 11 produces low-energy positive ions from application of an atomic ionisation process to a gas, such as one of the noble gases, for example argon, helium or xenon, chosen so as not to cause interstitial contamination of the metal lattice of the resulting metal part 3 formed at the build surface. Use of helium, which has the lowest mass and highest mobility of the noble gases, may aid the efficiency of the neutralisation process. The atomic ionisation process may be based on thermionic emission from a current-carrying tungsten filament to ionise the gas in a discharge chamber that sits at a positive bias potential with respect to ground. A plasma generated in this manner exits the discharge chamber via an aperture in the plasma source 11.

As illustrated in FIG. 1, the plasma source 11 is such that it is contained within the build vacuum chamber 5. Alternatively, the plasma source 11 may be contained in a separate vacuum chamber attached to the build vacuum chamber 5.

In alternative embodiments, the plasma source is a radio frequency plasma source, a hollow cathode plasma source or a duoplasmatron, but any other suitable plasma source can be used.

### Additive Manufacturing Method

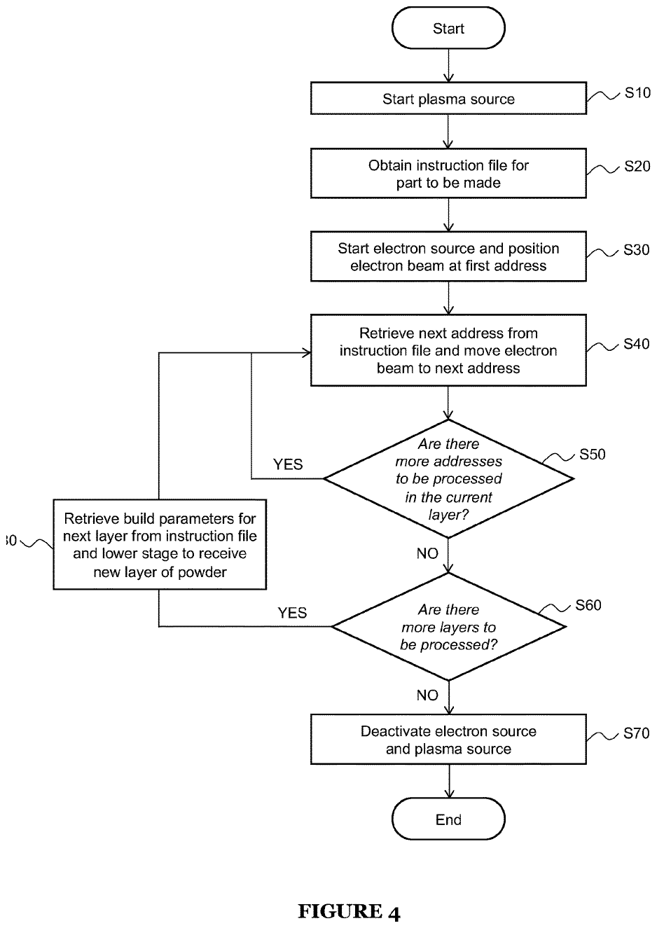

A method of additive manufacture using a powder bed fusion apparatus 1, according to embodiments of the present invention, is also provided, as illustrated with reference to FIG. 4, and described in conjunction with the powder fusion apparatus 1 described with reference to FIG. 1.

At step S10 the plasma source 11 is activated, and a region of plasma and neutral atoms 16a is formed between the plasma source 11 and the powder bed 2.

At step S20, the build controller obtains an instruction file for a part 3 to be made. The instruction file contains the computer-executable instructions to be followed by the controller to form the part 3, for example electron beam build parameters (e.g. beam energy, current, scan speed, spot-size) and a sequence of addresses on the powder bed 2 to position the electron beam 17 to form each layer of the part 3.

At step S30 the electron source 7 is activated. The build controller starts the electron source 7 in accordance with a specification of build parameters and positions the electron beam 17 at the first address retrieved from the instruction file. Embodiments of the present invention are compatible with any particular scan strategy. When the electron beam 17 is incident on the powder bed 2, it begins to melt the powder. Prior to melting the powder, step S30 may, in some embodiments, further include a pre-heating stage in which the area to be melted is heated prior to melting, so as to assist with the melting process. On activation of the electron source 7, the neutraliser coupling potential of the plasma source 11 self-adjusts to counteract the electron beam 17.

The positive ions 16 counteract the negative charge on the powder due to the electron beam 17, establishing an equilibrium potential on the area of the powder being melted.

At step S40, the build controller retrieves the next address from the instruction file and moves the electron beam 17 to the specified address on the powder bed 2. As the electron beam 17 moves over the powder bed 2, the electron beam 17 melts the powder to form a desired additive manufactured part 3.

At step S50 a decision is made by the build controller as to whether there are more addresses in the instruction file at which the electron beam 17 is to be positioned within the layer of the part 3 being produced. If there are more positions, the method returns (S50-Y) to step S40 and moves the electron beam 17 to the next position in the sequence of addresses in the instruction file. If there are no more positions within the layer (S50-N), the method proceeds to step S60.

At step S60 the build controller determines whether there are more layers in the instruction file to be processed. If there are no more layers to process (S60-N), the method proceeds to step S70 in which the electron source 7 and then the plasma source 11 are switched off, and the method subsequently ends. However, if not all layers have been processed, the method returns (S60-Y) via step S80 to step S40. In step S80, build parameters for the next layer for the electron beam 17 are retrieved from the instruction file, and the stage 20 is dropped and new powder spread to form the powder bed 2 for the next layer of the part 3. On return to step S40, the build controller retrieves the next address in the next layer from the instruction file and moves the electron beam 17 to the specified address on the powder bed 2, and the build continues.

In this way, the electron beam 17 may be scanned though all the addresses specified in the instruction file for each layer of the part 3 such that the part 3 is formed by additive layer manufacture. Since the electron source 7 and the plasma source 11 are connected via the same power supply, as set out above, it is ensured that the same current flows through both; thus, the plasma source 11 produces the exact ion current required to neutralise the negative charge due to the incident electron beam 17 as it is scanned over the powder bed 2.

It will be appreciated that the powder bed fusion apparatus can be configured in a number of different ways, depending on the requirements of a user for a particular build process, and compatible features of different embodiments may be readily combined.

1. A powder bed fusion apparatus for use in additive manufacturing, the apparatus comprising:
a power supply having an anode and a cathode;
an electron source operable to provide an electron beam, wherein the electron source is biased by the power supply;
a plasma source operable to provide a plasma containing electrons and positively charged ions;
a powder bed arranged to receive the electron beam and the plasma; and
a controller configured to control operation of the electron source and the plasma source to form a part as a series of layers, each layer formed by scanning the electron beam over the powder bed to fuse a layer of powder of the powder bed into a desired shape;
wherein the plasma source is connected to the anode of the power supply, enabling a circuit in which the ion current, formed by the positively charged ions in the plasma, is balanced by electron current, sourced from the plasma and returning to the power supply via the plasma, such that mitigation, by the ion current, of charging of the powder bed by the electron beam self-regulates.
